(19) United States
(12) Patent Application Publication
(10) Pub. No.: US 2013/0006670 A1
(43) Pub. Date: Jan. 3, 2013

(54) SYSTEM AND METHOD FOR LONGITUDINAL CONTINUITY OF CARE

(75) Inventors: W. T. GREEN, III, Carrollton, GA (US); James T. Ingram, Carrollton, GA (US); Gregory H. Schulenburg, Carrollton, GA (US); Jason Colquitt, Carrollton, GA (US); Steve Felt, Hamilton, GA (US)

(73) Assignee: Greenway Medical Technologies, Inc., Carrollton, GA (US)

(21) Appl. No.: 13/539,717

(22) Filed: Jul. 2, 2012

Related U.S. Application Data
(60) Provisional application No. 61/503,733, filed on Jul. 1, 2011.
(60) Provisional application No. 61/641,556, filed on May 2, 2012.

(51) Int. Cl. G06Q 50/24

(52) U.S. Cl. 705/3

(57) ABSTRACT

Health-care organizations are given access to clinical details about a patient captured from one or more encounters at one or more sites. The details are searched in a data warehouse, using a master person identifier identifying the patient. The details are then aggregated into a dynamic and interactive record.

### REFERENCE TO RELATED APPLICATIONS

The present application claims the benefit of U.S. Provisional Patent Application Nos. 61/503,733, filed Jul. 1, 2011, and 61/641,556, filed May 2, 2012, whose disclosures are hereby incorporated by reference in their entireties into the present disclosure.

### FIELD OF THE INVENTION

The present invention is directed to a system and method for allowing health-care organizations access to clinical details captured from one or more encounters. The present invention can be implemented on any computer-based medical records system, now or later to be developed, including without limitation stand-alone, LAN-based, and Internet-based medical records systems.

### DESCRIPTION OF RELATED ART

An electronic health record (EHR) is a systematic collection of electronic health information about individual patients or populations. When a patient visits or otherwise interacts with an organization providing health care, information from each patient visit or other interaction is added to the EHR.

However, a patient may receive health care from multiple facilities, each of which will generate its own EHR. Thus, information about the patient may be scattered across multiple organizations.

### SUMMARY OF THE INVENTION

There is thus a need in the art for a dynamic and interactive record of all information concerning a patient. It is therefore an object of the invention to provide such a record.

To achieve the above and other objects, the present invention in at least one embodiment provides EHR and Accountable Care Organizations access to clinical details captured from one or more encounters. Essentially, the present invention provides the assembly of records aggregated over the course of the duration of the patient's visits to multiple sites.

The value of the present invention in at least one embodiment is based on the need for a dynamic and interactive record, versus the current archived chronological repository of information, areas of application in research, clinical benefits and population related research concerning present and future influences upon a person's health.

The high-level process includes aggregating all of the patient information using a master person index (MPI) to correlate patient information from the research data warehouse.

The invention in at least on embodiment provides functionality to allow the patient record to be shared across multiple organizations.

The invention in at least one embodiment enhances the ability to market to clients that wish to allow patients to view all of their healthcare treatment among various sites.

### BRIEF DESCRIPTION OF THE DRAWINGS

A preferred embodiment of the present invention will be set forth in detail with reference to the drawings, in which:

FIG. 1 is a flow chart showing the operation of the preferred embodiment;

FIG. 2 is a screen shot showing a desktop screen through which the user accesses the system;

FIG. 3 is a screen shot showing a list of patient charts;

FIG. 4 is a screen shot showing a list of sites;

FIG. 5 is a screen shot showing the ability to search for a patient;

FIG. 6 is a screen shot showing a successful search result;

FIG. 7 is a screen shot showing an unsuccessful search result; and

FIG. 8 is a block diagram of hardware on which the preferred or another embodiment can be implemented.

### DETAILED DESCRIPTION OF THE PREFERRED EMBODIMENT

A preferred embodiment of the present invention will be set forth in detail with reference to the drawings, in which like reference numerals refer to like elements or steps throughout.

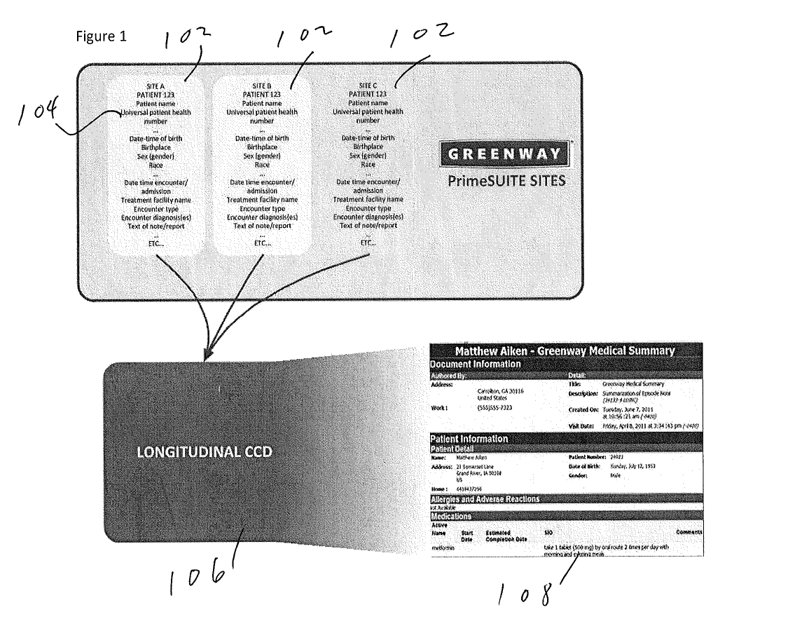

The preferred embodiment provides access to clinical details captured from one or more encounters across multiple sites. Patient information is aggregated using a master person index (MPI) to correlate patient information from the data repository and display the information as a seamless document. The document is not an editable document. The data is currently aggregated from the disparate databases installed at the client sites. As seen in the flow chart of FIG. 1, the preferred embodiment starts with multiple patient records 102 from different sites, which reside in a data warehouse. Each patient record 102 includes information about one or more patient encounters with that site and is indexed by information including a universal patient health number (MPI) 104. The multiple patient records 102 are processed in the longitudinal CCD process 106, in which those patient records 102 having the same universal patient health number 104 are aggregated to produce a single document 108 giving all information for the patient's encounters with the multiple sites.

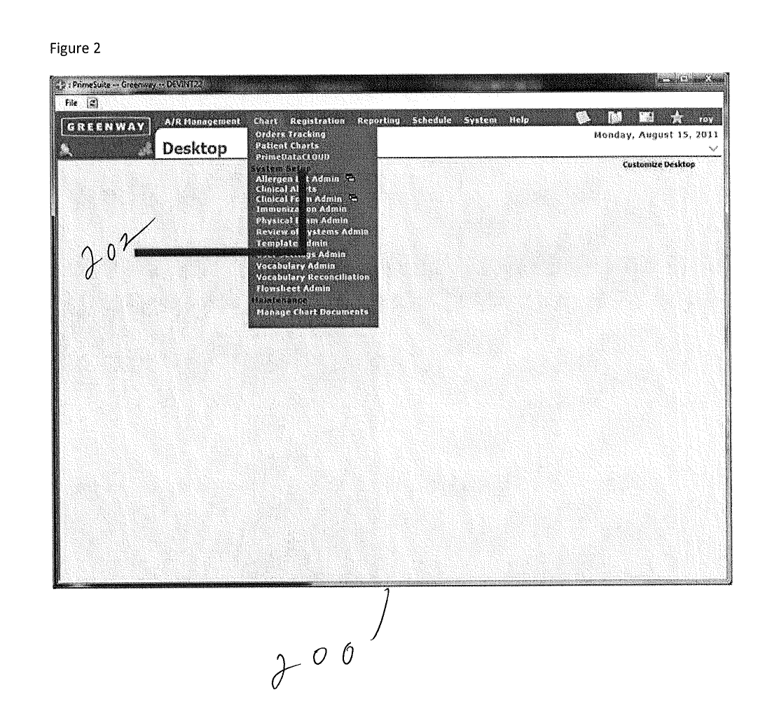

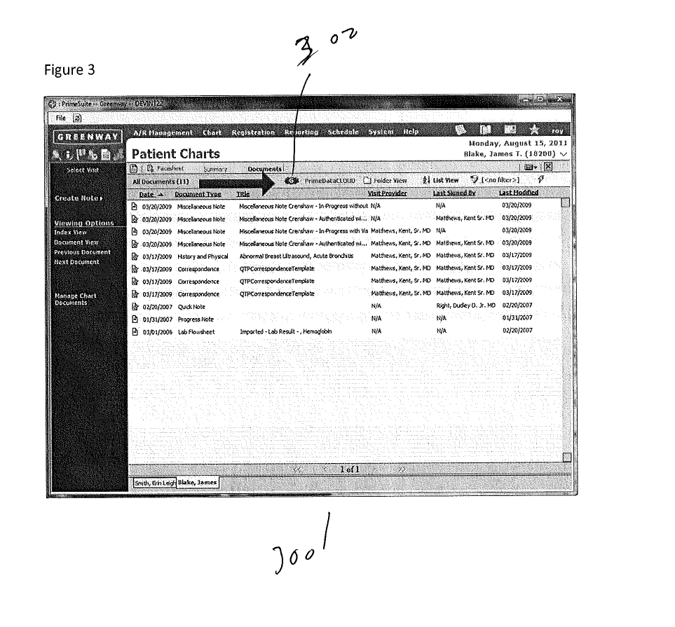

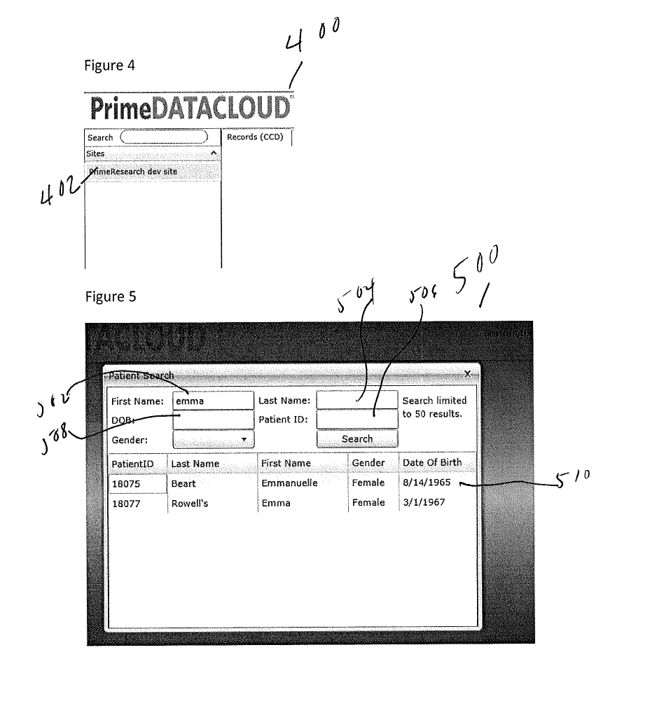

The process will now be described in greater detail. An administrator gives the user rights to access the process. The user can enter the portal through the menu item 202 in the desktop 200 of FIG. 2 or the button 302 in the list of patient charts 300 of FIG. 3 and begin to view the longitudinal patient records. The user will see a list of sites in the dropdown 402 on the left hand side of the screen 400 of FIG. 4.

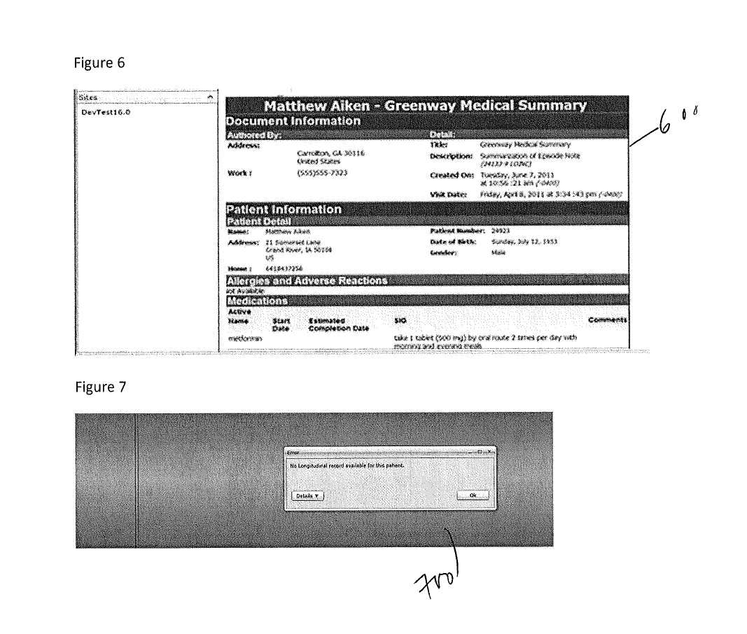

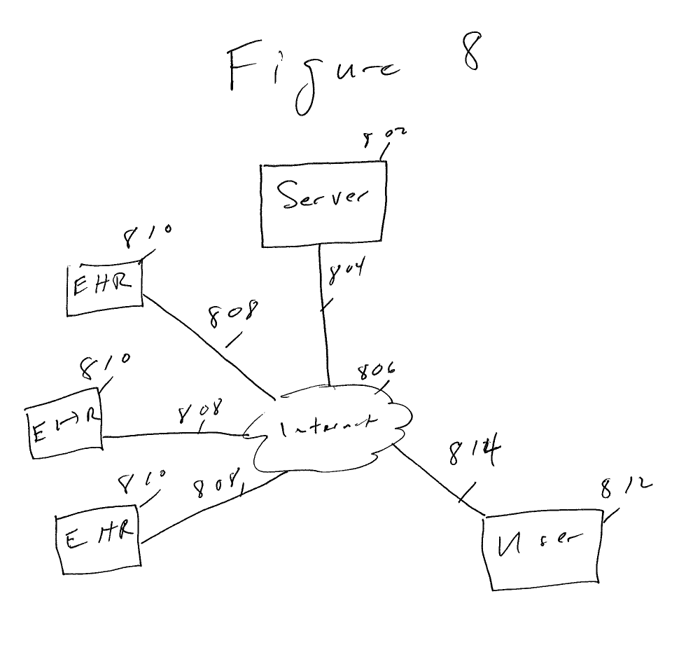

First, the user searches for a specific patient. Then, the user views that patient's longitudinal CCD (Continuity of Care Document) or Documents. When the user goes to search for a patient, “Patient Search” opens up in a new window 500 of FIG. 5. The user is able to search for patients by the “first name” field 502, the “last name” field 504, the “patient ID” field 506, or the “date of birth” field 508. One, multiple, or all criteria can be used to locate a specific patient. To select a patient from the list, the user clicks on the row 510 that contains the person's information. Once the patient is selected, either the longitudinal continuity of care document generated in FIG. 1, shown in FIG. 6 as 600, is displayed, or the user is informed that no such document exists for the patient, as shown in the dialog box 700 of FIG. 7.

An example of hardware on which the preferred or any other embodiment can be implemented is shown in FIG. 8. A server 802 is in communication by way of a communication link 804, the Internet or another suitable communication medium 806, and communication links 808 to EHR's 810 at multiple sites. The server 802, which implements a data warehouse (which alternatively may be provided separately), receives patient records from the EHR's 810 and processes them as shown in FIG. 1 to generate the longitudinal continuity of care document. A user uses a user device 812, which can be any suitable desktop, laptop, netbook, tablet, or other device capable of running a Web browser, to access the server 802 via a communication link 814. The server 802 is configured to implement the functionality described above and to provide suitable HTML pages to the user device 812. The communication links can be any suitable wired or wireless communication links. The users may be located at multiple organizations.

While a preferred embodiment has been set forth above, those skilled in the art who have reviewed the present disclosure will readily appreciate that other embodiments can be realized within the scope of the invention. For example, disclosures of specific technologies are illustrative rather than limiting, as are screen layouts. Therefore, the present invention should be construed as limited only by the appended claims.

What is claimed is:

1. A computer-implemented method for aggregating information about a patient, the information comprising records from the patient's visits to multiple sites, the method comprising:
(a) accessing a data warehouse on which the information is stored;
(b) receiving a master person index (mpi) representing the patient;
(c) searching the data warehouse for the information, using the mpi; and
(d) receiving the information from the data warehouse into a processing device and aggregating the information in the processing device to provide a longitudinal continuity of care document.

2. The method of claim 1, wherein the longitudinal continuity of care document is a non-editable document.

3. The method of claim 1, wherein the longitudinal continuity of care document comprises an interactive and dynamic record.

4. The method of claim 1, wherein the longitudinal continuity of care document is electronically made available to processing devices located at a plurality of organizations.

5. The method of claim 1, wherein the information stored in the data warehouse is received from electronic health records at multiple sites.

6. The method of claim 1, further comprising providing a user with an ability to search for the longitudinal continuity of care document for the patient.

7. The method of claim 6, wherein the user may search for the patient by at least one of the patient's first name, last name, patient ID number, and date of birth.

8. A computer-implemented system for aggregating information about a patient, the information comprising records from the patient's visits to multiple sites, the system comprising:
a processor configured for:
(a) accessing a data warehouse on which the information is stored;
(b) receiving a master person index (mpi) representing the patient;
(c) searching the data warehouse for the information, using the mpi; and
(d) receiving the information from the data warehouse into a processing device and aggregating the information in the processing device to provide a longitudinal continuity of care document; and
a communication component, in communication with the processor, for electronically providing the longitudinal continuity of care document to a user.

9. The system of claim 8, wherein the processor is configured such that the longitudinal continuity of care document is a non-editable document.

10. The system of claim 8, wherein the processor is configured such that the longitudinal continuity of care document comprises an interactive and dynamic record.

11. The system of claim 8, wherein the processor is configured to make the longitudinal continuity of care document available over the communication component to processing devices located at a plurality of organizations.

12. The system of claim 8, wherein the processor is configured to provide the user with an ability to search for the longitudinal continuity of care document for the patient.

13. The system of claim 12, wherein the processor is configured to allow the user to search for the patient by at least one of the patient's first name, last name, patient ID number, and date of birth.
